(19) United States
(12) Patent Application Publication
(10) Pub. No.: US 2012/0011468 A1
(43) Pub. Date: Jan. 12, 2012

(54) INFORMATION PROCESSING APPARATUS AND METHOD OF CONTROLLING A DISPLAY POSITION OF A USER INTERFACE ELEMENT

(75) Inventor: Qi Zhang, Ome-shi (JP)

(73) Assignee: KABUSHIKI KAISHA TOSHIBA, Tokyo (JP)

(21) Appl. No.: 13/166,262

(22) Filed: Jun. 22, 2011

(30) Foreign Application Priority Data
Jul. 6, 2010 (JP) 2010-154276

(51) Int. Cl. G06F 3/048

(52) U.S. Cl. 715/788

(57) ABSTRACT

According to one embodiment, an apparatus which is executable a browser, a player and a first software, the player being plug-in of the browser and configured to play back video content and to output video data to display a video based on the video data in a first sub-window of the browser, the first software being a plug-in of the browser and configured to display a user interface element in a second sub-window of the browser whose layer is higher than a layer of the first sub-window, the apparatus includes a determination module configured to determine whether a third sub-window different from the first sub-window and the second sub-window is displayed in a first area, and a display module configured to display the second sub-window in the first area when it is determined that the third sub-window is not displayed in the first area.

### CROSS-REFERENCE TO RELATED APPLICATIONS

This application is based upon and claims the benefit of priority from Japanese Patent Application No. 2010-154276, filed Jul. 6, 2010; the entire contents of which are incorporated herein by reference.

### FIELD

Embodiments described herein relate generally to an information processing apparatus, which plays back video content received from a server, and to a method of controlling a display position of a user interface element, which is applied to the same apparatus.

### BACKGROUND

In recent years, miscellaneous content published on Web sites on the Internet has become widely accessed using a browser of a personal computer. Moreover, by using a moving image playback program browser plug-in miscellaneous image content such as videos and home movies is displayable.

Recently, products capable of performing resolution conversion and full-screen display have become available on the market. With resolution conversion, the resolution of acquired video content is converted to high resolution. With full-screen display, the acquired video content is subjected to image quality enhancement processing, and then the content is displayed in full-screen mode on the display device of a personal computer. In addition, software capable of executing video capture is on the market. With video capture, video content data is captured so that it is stored in a storage medium of a personal computer.

There exists a technique of displaying a user interface element for executing the foregoing resolution conversion, image quality enhancement processing and video capture in a state of being adjacent to an area in which video content is displayed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view to explain a state of using a data processing apparatus according to an embodiment.

FIG. 2 is an exemplary block diagram showing the system configuration of a data processing apparatus according to an embodiment.

FIG. 3 is an exemplary block diagram showing the software configuration of a data processing apparatus according to an embodiment.

FIG. 4 is an exemplary view showing one example of a browser screen image displayed on a display device of a data processing apparatus according to an embodiment.

FIG. 5 is an exemplary view showing one example of a screen image of a moving image displayed on a display device of a data processing apparatus according to an embodiment.

FIG. 6 is an exemplary view showing one example of a browser screen image displayed on a display device of a data processing apparatus according to an embodiment.

FIG. 7 is an exemplary view showing one example of a browser screen image displayed on a display device of a data processing apparatus according to an embodiment.

FIG. 8 is an exemplary view showing the relationship between a window and a layer, which are managed by an operating system executed by a data processing apparatus according to an embodiment.

FIG. 9 is an exemplary block diagram showing the configuration for realizing a function of performing a display so that a “Resolution+” button according to an embodiment is not overlapped by a graphical user interface (GUI) element such as other buttons.

FIG. 10 is an exemplary view showing a sub-window and a display intended position according to an embodiment.

FIG. 11 is an exemplary view to explain a process executed by an overlap determination unit according to an embodiment.

FIG. 12 is an exemplary flowchart to explain the processing procedure of determining whether or not a sub-window except a sub-window displaying a moving image under a display intended position is displayed.

FIG. 13 is an exemplary view showing one example of a browser screen image displayed on a display device of a data processing apparatus according to an embodiment.

FIG. 14 is an exemplary view to explain a process executed by an overlap determination unit according to an embodiment.

FIG. 15 is an exemplary flowchart to explain an image quality enhancement processing program after a sub-window according to an embodiment is displayed.

### DETAILED DESCRIPTION

Various embodiments will be described hereinafter with reference to the accompanying drawings.

In general, according to one embodiment, an information processing apparatus which is executable a browser, a player software and a first software, the player software being plug-in of the browser and configured to play back video content received from a server and to output video data to display a video based on the video data in a first sub-window of the browser, the first software being a plug-in of the browser and configured to display a user interface element in a second sub-window of the browser whose layer is higher than the first sub-window and to execute a process in accordance with an operation with respect to the user interface element, the apparatus includes a determination module and a display module. The determination module configured to determine whether a third sub-window different from the first sub-window and the second sub-window is displayed in a first area. The display module configured to display the second sub-window in the first area when determined that the third sub-window is not displayed in the first area.

An embodiment will be described below with reference to the accompanying drawings.

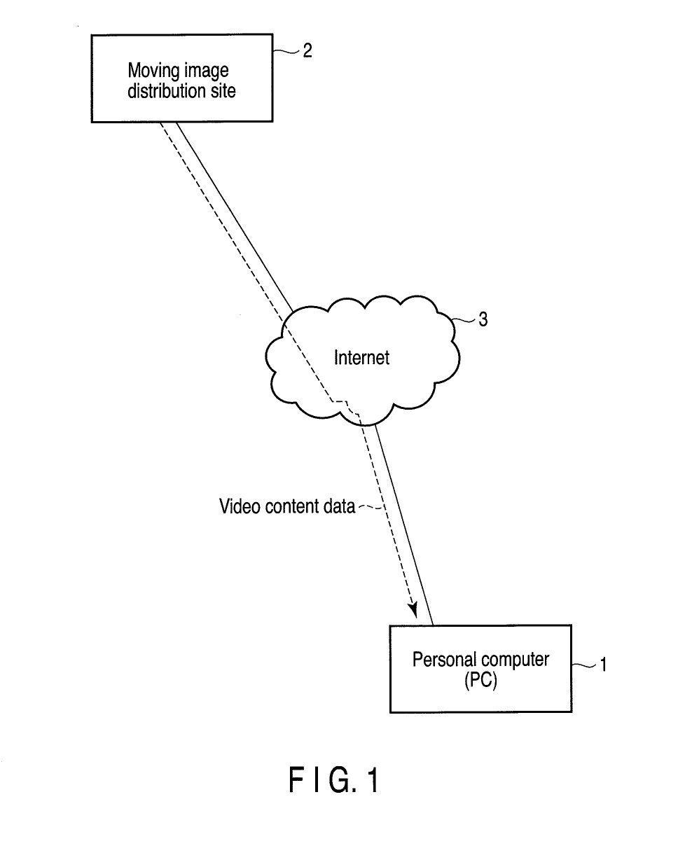

A state of using a data processing apparatus according to one embodiment will be described with reference to FIG. 1. This data processing apparatus is realized as a notebook personal computer (PC) 1, for example. A personal computer 1 is able to access each Web site on the Internet 3. A Web site includes a moving image distribution site 2 for sharing video content data such as a home video created by a user. The moving image distribution site 2 publicly opens various items of video content data such as videos and home movies uploaded by each user. Video content data published by the moving image distribution site 2 is two-dimensional content. The user of the personal computer 1 can playback video content data provided by the moving image distribution site 2 while receiving it by way of the Internet 3. Access to the distribution site 2 is executed by software executed by the computer 1, for example, a Web browser. Video content data on the moving image distribution site 2 includes video content coded according to various types of coding. Reception and playback of video content from the distribution site 2 are executed by a moving image playback program browser plug-in, for example. The moving image playback program is player software for playing back video content received from a server such as the moving image distribution site 2. The moving image playback program plays back video content while receiving the video content by streaming, for example. Two-dimensional video data obtained by playing back the video content is displayed on a display device of the personal computer 1 according to the control of an operating system.

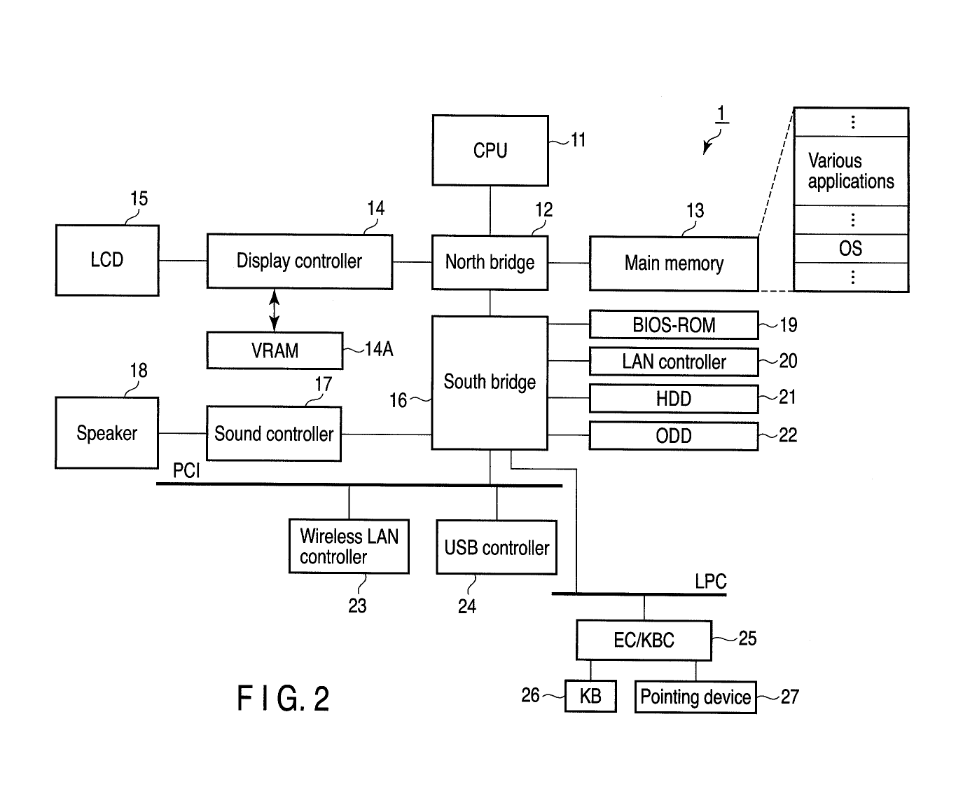

FIG. 2 is a block diagram showing the system configuration of the computer 1.

As shown in FIG. 2, the computer 1 includes a CPU 11, a north bridge 12, a main memory 13, a display controller 14, a video memory (VRAM) 14A, a liquid crystal display (LCD) 15, a south bridge 16, a sound controller 17, a speaker 18, a BIOS-ROM 19. Further, the computer 1 includes a LAN controller 20, a hard disk drive (HDD) 21, an optical disk drive (ODD) 22, a wireless LAN controller 23, a USB controller 24, an embedded controller/keyboard controller (EC/KBC) 25, a keyboard (KB) 26 and a pointing device 27

The CPU 11 is a processor, which controls the operation of the computer 1. The CPU 11 executes an operating system (OS) and various application programs, which are loaded from the RED 21 to the main memory 13. The foregoing browser and moving image playback program are included in the application program. Further, an image quality enhancement processing program is included in the application program. The image quality enhancement processing program executes a super-resolution process with respect to a video played back by the moving image playback program so that full-screen display of the processed video is achieved on the LCD 15. Moreover, a graphics control engine is included in the application program. In this case, the foregoing image quality enhancement processing program and graphics control engine may be provided from another vendor.

In addition, the CPU 11 executes a Basic Input/Output System (BIOS) stored in the BIOS-ROM 19. The BIOS is a program for controlling hardware.

The north bridge 12 is a bridge device, which makes a connection between a local bus of the CPU 11 and the south bridge 16. The north bridge 12 has a built-in memory control for controlling the access to the main memory 13. Further, the north bridge 12 has a function of performing a communication with the display controller 14.

The display controller 14 is a device, which controls the LCD 15 used as a display device of the computer 1. For example, the LCD 15 may be realized as a touch screen device, which is capable of detecting a position touched by a pen or finger. In this case, the LCD 15 is provided with a transparent coordinate detector 15B, which is called a tablet or touch panel.

The south bridge 16 controls each device on a Peripheral Component Interconnect (PCI) bus and on a Low Pin Count (LPC) bus. The south bridge 16 has a built-in Integrated Drive Electronics (IDE) controller for controlling the HOD 21 and ODD 22, and a built-in memory controller for controlling the access to the BIOS-ROM 19. Further, the south bridge 16 has a function of performing a communication with the sound controller 17 and the LAN controller 20.

The sound controller 17 is a sound source device, and outputs audio data of a playback target to the speaker 18. The LAN controller is a wired communication device, which executes a wired communication conforming to the Ethernet (registered trademark) standard, for example. The wireless LAN controller 23 is a wireless communication device, which executes a wireless communication conforming to the IEEE 802.11 standard, for example. The USB controller 24 executes a communication with an external apparatus by way of cable conforming to the USB 2.0 standard, for example.

The EC/KBC 25 is a one-chip microcomputer, which is integrated with an embedded controller for executing a power management and a keyboard controller for controlling the keyboard (KB) 25 and the pointing device 27. The EC/KBC 25 has a function of turning on/off the power of the computer 1 in accordance with an operation by the user.

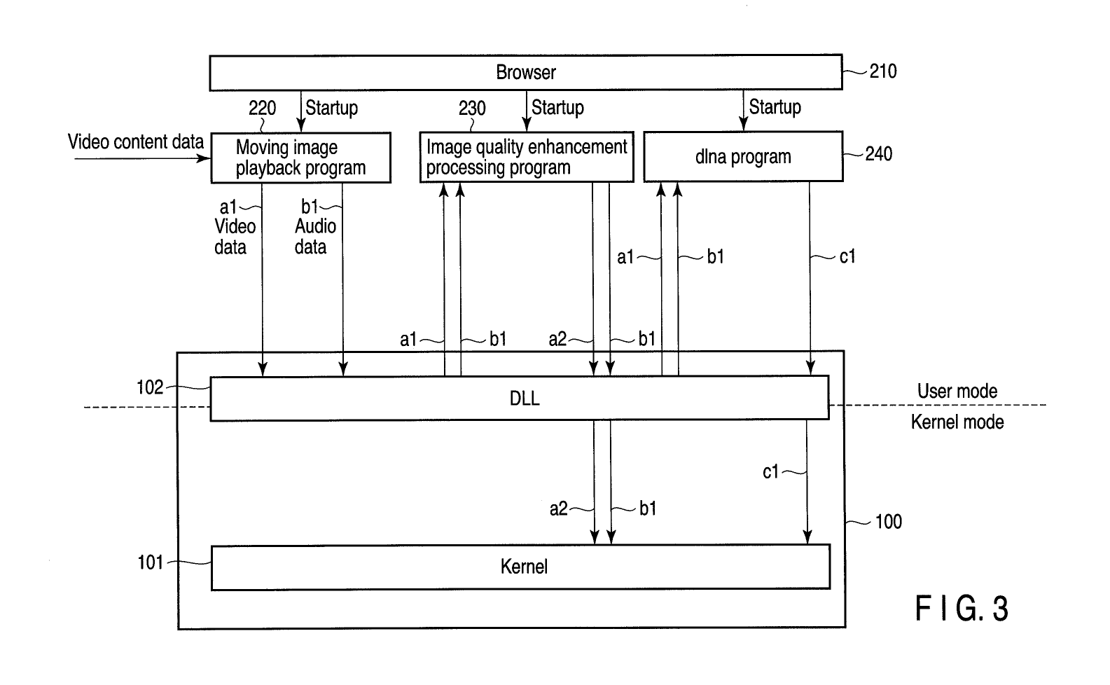

As can be seen from FIG. 3, an operating system (OS) 100, a browser 210, a moving image playback program 220, an image quality enhancement processing program 230 and a capture program 240 are installed in the computer 1. Each of the foregoing moving image playback program 220, image quality enhancement processing program 230 and capture program 240 is a plug-in of the browser 210.

The OS 100 controlling the resource management the computer 1 includes a kernel 101 and a dynamic link library (DLL) 102. The kernel 101 is a module, which controls various devices (hardware) of the computer 1 shown in FIG. 2. The DLL 102 is a module (application programming interface [API]), which provides an interface with the kernel 101 to an application program.

A hierarchy until various application programs issue various requests to the DLL 102 is called as a user mode. A hierarchy after that, that is, until the DLL 102 transmits the foregoing requests to the kernel 101 is called as a kernel mode.

When browsing a Web page on the moving image distribution site 2, the browser 210 determines whether or not the Web page is a Web page including content such as a video according to tag data of the Web page. If the Web page is a Web page including content such as a video, the browser 210 starts up the moving image playback program 220 plug-in of the browser 210. Then, when the user performs an operation for instructing playback start of video content such as a video while browsing the Web page, the moving image playback program 220 starts to receive the video content from the moving image distribution site 2.

The moving image playback program 220 plays back video content data while receiving the video content data by streaming. The program 220 plays back video content data, and thereby, generates two-dimensional video data a1, which is drawing data to be displayed on a display device, and audio data b1 to be output from a speaker. Then, the program 220 output the video data a1 to the DLL 102 of the OS 100 as a video to be displayed on a browser screen, and outputs the audio data b1 to the DLL 102 of the OS 100.

Usually, the foregoing video data a1 and audio data b2 transferred to the DLL 102 is subjected to a format check in the DLL 102, and thereafter, supplied to the kernel 101. The kernel 101 executes a process for displaying video data received from the DLL 102 on the LCD 15 and a process for outputting audio data received from the DLL 102 via the speaker 18.

The image quality enhancement processing program 230 is a program, which is incorporated into the browser 210 as resident plug-in software. The program 230 is automatically started up with the startup of the browser 210. In order to execute the foregoing image quality enhancement display function, the program 230 has the following functions:

1. Function of capturing video data (drawing data) obtained by playing back (decoding) video content data from the moving image playback program 220;

2. Function of removing repetition of a frame using a frame rate fluctuation suppression process;

3. Function of removing a digital noise by a noise removal process;

4. Function of making an interpolation between frames by a frame double-speed process;

5. Function of analyzing an image using a super-resolution process, and thereafter, enhancing a resolution (converting a SD image into a HD image)

6. Function of adjusting color to be converted into a vivid image, and displaying the image; and

7. Function of performing a full screen display of an image.

The image quality enhancement processing program 230 captures video data a1 and audio data b1 output from the moving image playback program 220 to the OS 100 during playback of video content data. The moving image playback program 220 outputs the foregoing video data a1 and audio data b1 to the OS 100. Therefore, the program 230 is able to capture video data a1 and audio data b1 output from the moving image playback program 220 via the OS 100. In this way, the program 230 executes removal of frame repetition, digital noise removal, interpolation between frames, enhancement of resolution, image quality conversion and full-screen display.

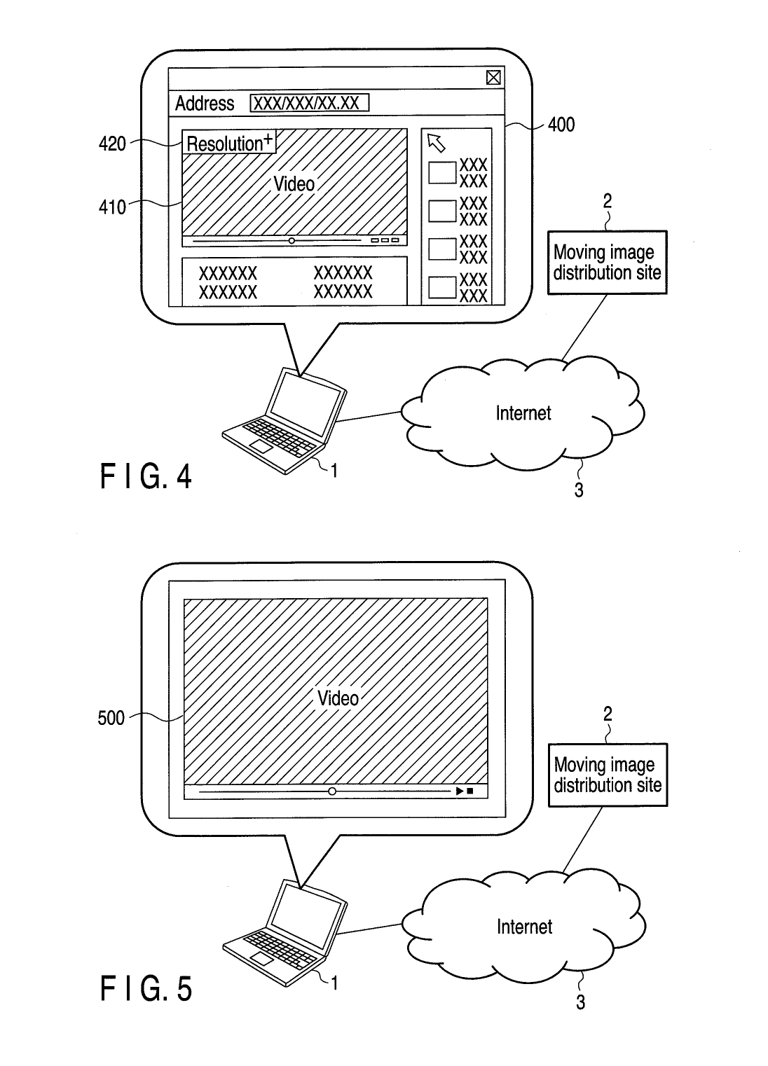

FIG. 4 shows one example of a browser screen image displayed on the LCD 15. A browser parent window 400 is displayed on the screen of the LCD 15. As described above, decoding and playback of video content data received from the moving image distribution site 2 are executed by the moving image playback program 220 browser plug-in. The video content data includes coded video data and coded audio data, for example. The moving image playback program 220 decodes each of the foregoing video data and audio data, and thereafter, outputs decoded video data and decode audio data. A moving image corresponding to the decoded video data is displayed in a video display area 410 arranged in the browser parent window 400. Various control objects for controlling the playback video data are displayed in the video display area 410. In this case, the displayed control objects include a time bar, a playback button and a stop button, for example. Specifically, the time bar shows a playback position of video data. The playback button is used for playback video data. The stop button stops the playback of video data.

Moreover, the image quality enhancement processing program 230 displays a “Resolution+” button 420 in the video display area 410, as shown in FIG. 4. The “Resolution+” button 420 functions as a graphical user interface (GUI) element for making it possible to execute a display instruction by the user. The size (degree of resolution) of the “Resolution+” button 420 is optionally set by a vendor, which provides the image quality enhancement processing program 230. When the foregoing “Resolution+” button 420 is clicked by a mouse operation, the program 230 starts a display process.

The image quality enhancement processing program 230 starts to capture output data of the moving image playback program 220 to be displayed in the video display area 410. Then, the program 230 executes an image quality enhancement process with respect to the captured data. In this case, as can be seen from FIG. 5, the program 230 displays a moving image corresponding to the video data in a window 500 occupying the whole of the screen of the LCD 15.

The capture program 240 is a program, which is incorporated into the browser 210 as resident plug-in software, and started up with the startup of the browser 210.

The capture program 240 captures video data a1 and audio data b1 output from the moving image playback program 220 to the OS 100 during playback of video content data. The moving image playback program 220 outputs the foregoing video data a1 and audio data b1 to the OS 100. Therefore, the capture program 240 is able to capture video data a1 and audio data b1 output from the moving image playback program 220. Then, the capture program 240 generates AV data in which the foregoing captured video data a1 and audio data b1 are overlapped. Further, the capture program 240 transfers generated AV data c1 to the kernel 101 to give instructions to store the AV data in the main memory 13. In this case, the capture program 240 may store the generated AV data c1 in the HOD 21.

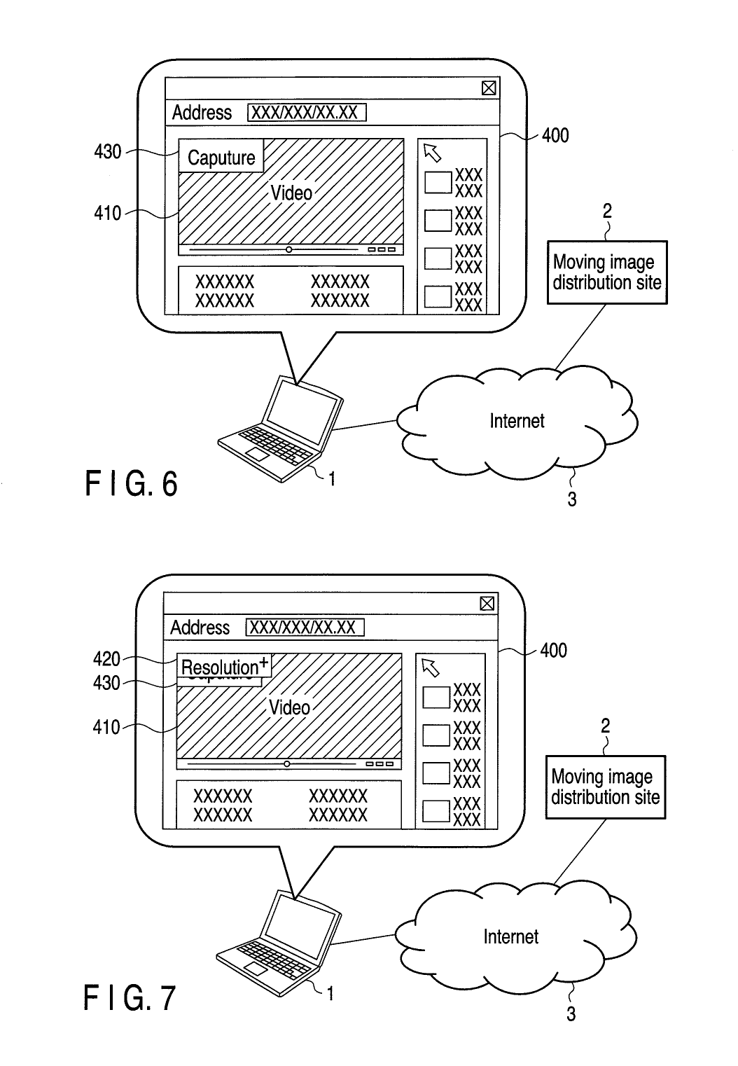

Moreover, as can be seen from FIG. 6, the capture program 240 displays a “Capture” button 430 in the video display area 410. The “Capture” button 430 functions as a graphical user interface (GUI) element for making it possible to execute a capture instruction by the user. The size (degree of resolution) of the “Capture” button 430 is optionally set by the vendor which provides the capture program 240. When the foregoing “Capture” button 430 is clicked by a mouse operation, the capture program 240 starts a capture process. Then, the capture program 240 starts to capture output data of the moving image playback program 220 to be displayed in the video display area 410. The capture program 240 converts the captured data into AV data, and thereafter, records the converted AV data in the main memory 13.

In this case, on the screen shown in FIG. 4, the personal computer 1 omits the display of the “Capture” button 430. Moreover, on the screen shown in FIG. 6, the personal computer 1 omits the display of the “Resolution+” button 420. If the display of “Capture” button 430 and “Resolution+” button 420 is not omitted as described above, the following disadvantage occurs. Namely, as shown in FIG. 7, there is a possibility that the foregoing “Capture” button 430 and “Resolution+” button 420 are displayed in a state of being overlapped.

The up and down position of the button in the video display area is determined depending on the order of the read plug-in. For example, if the capture program 240 is read earlier than the image quality enhancement processing program 230, the “Resolution+” button 420 is displayed on the “Capture” button 430, as seen from FIG. 7.

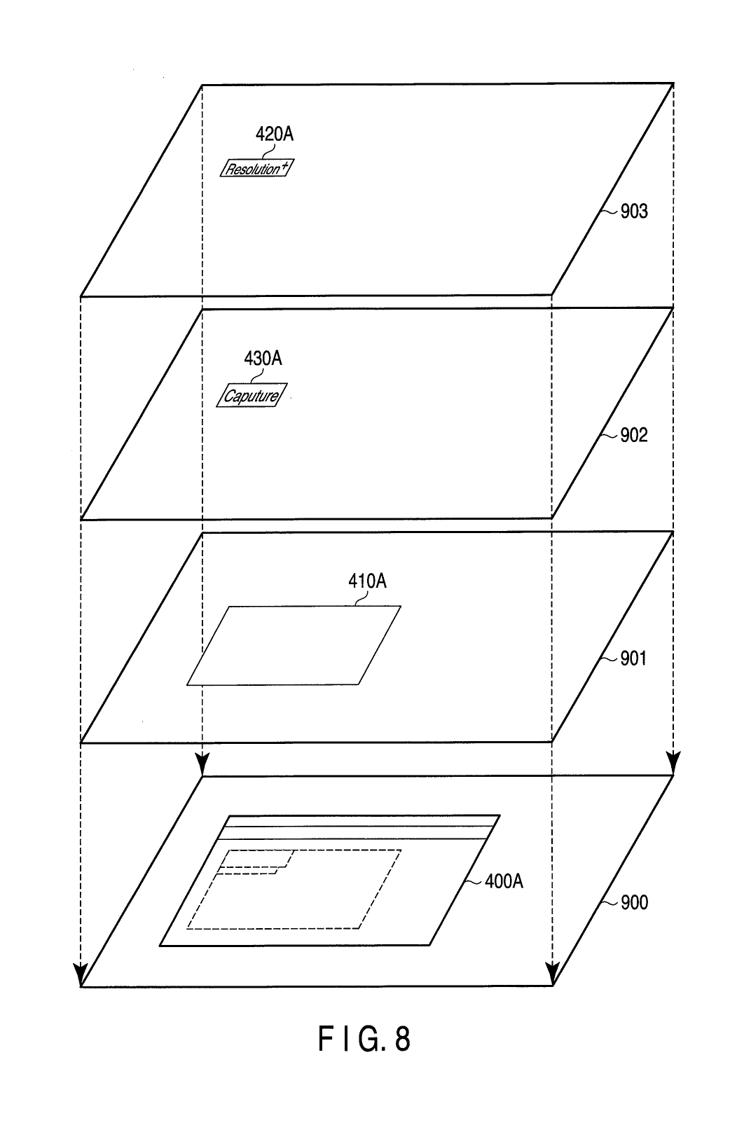

The operating system manages a window state shown in FIG. 7 displayed by the browser in a manner shown in FIG. 8. The operating system manages a parent window 400A, a sub (child) window 410A, a sub (child) window 420A and a sub (child) window 430A. The parent window 400A is a window displayed by the browser 400. Sub-window 410A is a window in which the video display area 410 is displayed. Sub-window 420A is a window in which the “Resolution+” button 420 is displayed. Sub-window 430A is a window in which the “Capture” button 430 is displayed.

Moreover, the operating system manages a parent window layer 900, a sub (child) window layer 901, a sub (child) window layer 902 and a sub (child) window layer 903. The parent window layer 900 is a layer having the parent window 400A. Sub-window layer 901 is a layer having sub-window 410A. Sub-window layer 902 is a layer having sub-window 430A. Sub-window layer 903 is a layer having sub-window 420A.

Further, the operating system manages a display overlapping state of vide display area 410, “Capture” button 430 and “Resolution+” button 420 using the foregoing sub-window layers 901 to 803.

The image quality enhancement processing program 230 further has a function of displaying the “Resolution+” button 420 so that the button 420 is not overlapped by the “Capture” button 430 in addition to the foregoing function.

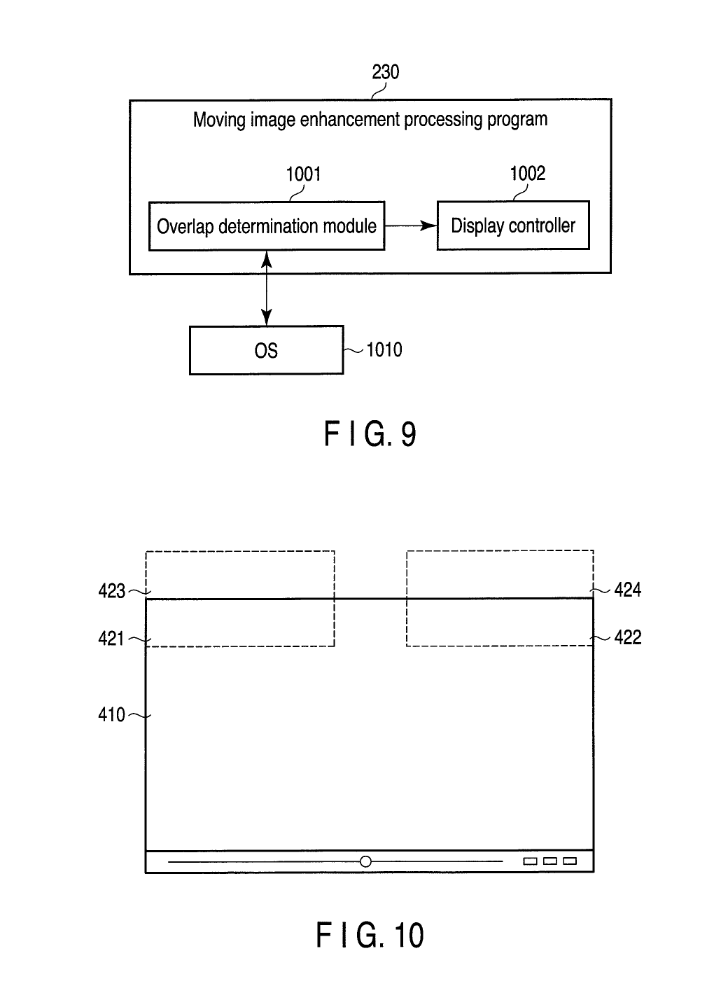

FIG. 9 is a block diagram showing the configuration for realizing a display such that the “Resolution+” button 420 is not overlapped by GUI elements such as other buttons.

As can be seen from FIG. 9, the image quality enhancement processing program 230 includes an overlap determination unit 1001 and a display controller 1002.

As can be seen from FIG. 10, for example, four display intended positions 421 to 424 are set as the display position of sub-window 420A having the “Resolution+” button 420. In this case, the size (resolution) of these display intended positions is set correspondingly to the size (resolution) of the GUI element of the “Resolution+” button 420, that is, the size (resolution) of sub-window 420A. Moreover, priority is set to the foregoing four display intended positions 421 to 424. Specifically, of the foregoing four display intended positions, the display intended position 421 has the highest priority, and the priority becomes low in the order of the display intended position 422, the display intended position 423 and the display intended position 424. The overlap determination unit 1001 determines whether or not a sub-window is displayed in sub-window 410A in a display intended position. Further, the unit 1001 detects a position such that sub-window 420A is not overlapped by sub-windows other than sub-window 410A.

The process of determining whether or not a sub-window is displayed in sub-window 410A in a display intended position will be described below giving the display intended position 421 as an example.

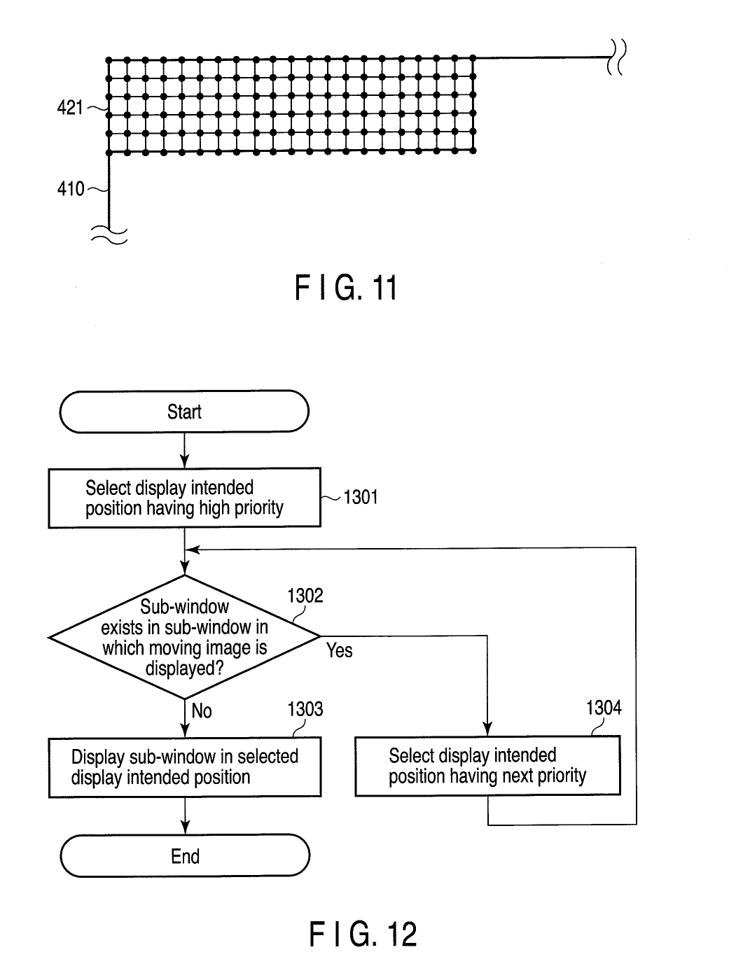

The overlap determination unit 1001 selects one of a plurality of positions (black points) in the display intended position shown in FIG. 11. Then, the unit 1001 acquires sub-window data at the position from an operating system 1010. The foregoing sub-window data includes the following data. Specifically, one is data of showing whether or not sub-window 410A and sub-windows other than sub-window 410A exist in the position selected by the overlap determination unit 1001. The other is data of showing the high-and-low relationship of layers including these windows.

The overlap determination unit 1001 determines whether or not a sub-window is displayed in sub-window 410A with respect to one position of the display intended position 421 based on the sub-window data acquired from the operating system 1010.

For example, the overlap determination unit 1001 determines that a sub-window is not displayed in a layer higher than sub-window 410A in one position selected from the display intended position 421. In this case, the unit 1001 successively determines whether or not a sub-window is displayed in sub-window 410A with respect to other positions (black points).

For example, the overlap determination unit 1001 determines that a sub-window is not displayed in a layer higher than sub-window 410A in the display intended position 421 with respect to all positions (black points). In this case, the unit 1001 determines that a sub-window other than sub-window 410A is not displayed in the display intended position 421

Moreover, when determining that a sub-window other than sub-window 410A is not displayed in the display intended position 421, the overlap determination unit 1001 transfers display intended position data to the display controller 1002. Then, based on the transferred display intended position data, the display controller 1002 displays sub-window 420A having the “Resolution+” button 420.

Conversely, the overlap determination unit 1001 determines that a sub-window other than sub-window 410A is displayed in the display intended position. In this case, the unit 1001 executes the foregoing process with respect to a display intended position having the priority lower than the determined display intended position. Then, the unit 1001 determines whether or not a sub-window other than sub-window 410A is displayed in the display intended position. Thereafter, the unit 1001 displays sub-window 420A in the display intended position in which a sub-window other than sub-window 410A is not displayed.

The procedure of determining whether or not a sub-window other than sub-window 410A is displayed under the display intended position will be described with reference to a flowchart shown in FIG. 12.

First, the overlap determination unit 1001 selects the display intended position 421 having the highest priority (block S1301). The unit 1001 determines whether or not a sub-window is displayed in a layer higher than sub-window 410A having the video display area 410 in the display intended position 421 (block S1302). If it is determined that a sub-window is displayed (Yes in block S1302), the unit 1001 selects a display intended position having the next priority (block S1304). Then, the unit 1001 again executes the procedure of block 1302.

Conversely, in block 1302, if it is determined in block S1302 that a sub-window is displayed (No in block 1302), the overlap determination unit 1001 transfers data of the selected display intended position to the display controller 1002. The display controller 1002 executes a process of displaying sub-window 420A in a transferred display intended position, and thus, displays sub-window 420A in the transferred display intended position (block S1303).

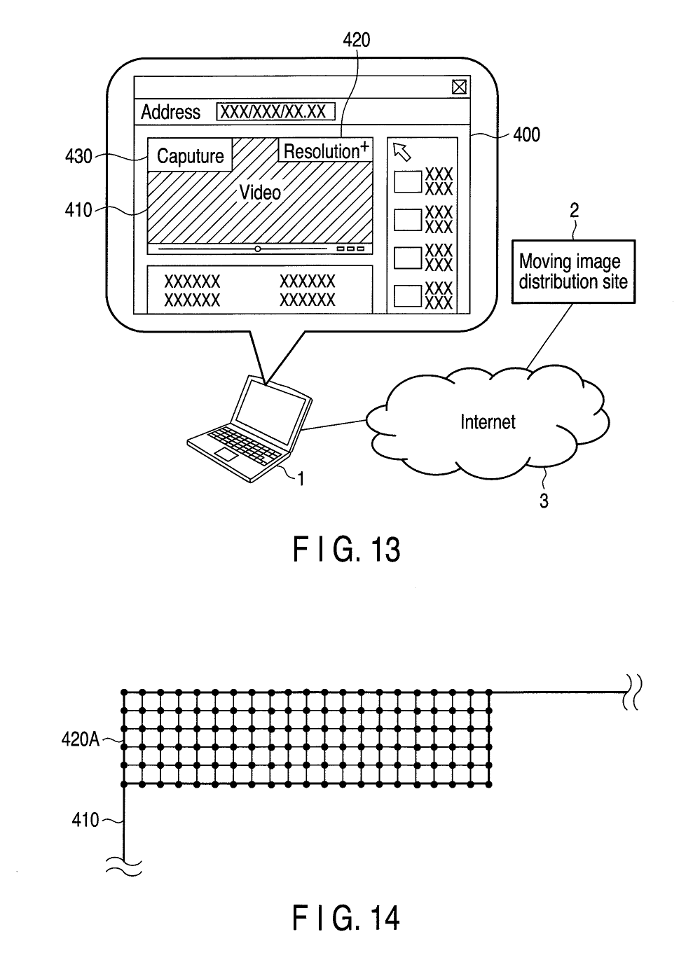

According to the foregoing procedure, it is possible to prevent another user interface element from being displayed in the position of the “Resolution+” button 420. For example, as shown in FIG. 13, a display is made so that the “Resolution+” button 420 is not overlapped by the “Capture” button 430. On a screen shown in FIG. 13, when receiving an operation input of the “Resolution+” button 420, the personal computer 1 displays the video display screen shown in FIG. 5. Moreover, when receiving an operation input of the “Capture” button 430, the personal computer 1 starts to capture video data.

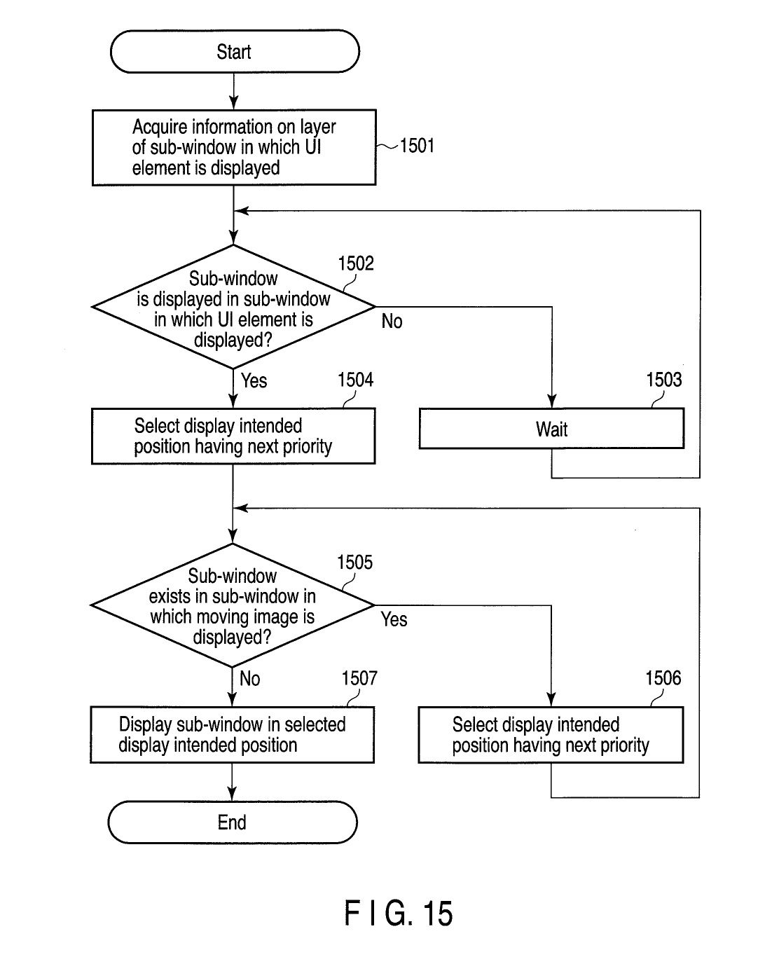

In addition, the overlap determination unit 1001 transfers display intended position data to the display controller 1002. Then, he unit 1001 periodically determines whether or not a sub-window is displayed in sub-window 420A after sub-window 420A is displayed. The foregoing determination procedure will be described below with reference to FIGS. 14 and 15.

The overlap determination unit 1001 acquires sub-window data on one position, which is selected from a plurality of positions (black points) of sub-window 420A shown in FIG. 14, from the operating system 1010.

Then, the overlap determination unit 1001 determines whether or not a sub-window other than sub-window 420A is displayed in the position of sub-window 420A with respect to the selected one position of sub-window 420A.

Thereafter, the overlap determination unit 1001 determines that a sub-window is not displayed in sub-window 420A with respect to a selected one position of the display intended position 421. Then, the unit 1001 successive executes the foregoing determination with respect to other positions (black points). If the unit 1001 determines that a sub-window is not displayed in sub-window 420A with respect to all positions, the unit 1001 determines that another window is not displayed in the position of sub-window 420A.

Conversely, when determining that another window is displayed in sub-window 420A, the overlap determination unit 1001 executes the following procedure. Specifically, the unit 1001 executes the same process as above with respect to display intended positions 421 to 424, namely, another display intended position having the priority lower than the display intended position corresponding to the position in which sub-window 420A is currently displayed. Then, the unit 1001 determines whether or not a sub-window other than sub-window 410A is displayed in the foregoing other display intended position.

When determining that a sub-window other than sub-window 410A is displayed in the foregoing other display intended position, the overlap determination unit 1001 transfers display intended position data to the display controller 1002. Based on the transferred display intended position data, the display controller 1002 executes a process of displaying sub-window 420A having the “Resolution+” button 420.

The procedure by the image quality enhancement processing program 230 after sub-window 420A is displayed will be described below with reference to a flowchart shown in FIG. 15.

First, the overlap determination unit 1001 acquires data on sub-window 420A in which a user interface (UI) element of the image quality enhancement processing program 230 is displayed from the operating system 1010 (block 1501). In this case, data of sub-window layer 420 includes data on a display position in which sub-window layer 420A is displayed.

Then, the overlap determination unit 1001 selects one of a plurality of positions (black points) in the display position of sub-window layer 420A shown in FIG. 14. Thereafter, the unit 1001 acquires data of a sub-window at the selected position from the operating system 1010. The foregoing data of the sub-window includes the following data. Specifically, one is data showing whether or not sub-window 410A and a sub-window other than sub-window 410A exist in the position selected by the overlap determination unit 1001. The other is data showing the up-and-down relationship of a layer including the foregoing sub-windows.

The overlap determination unit 1001 determines whether or not a sub-window is displayed in sub-window 420A based on the display position of sub-window 420A and data of a sub-window layer (block 1502). If it is determined that a sub-window is not displayed in sub-window 420A (No in block 1502), the overlap determination unit 1001 waits for a predetermined time (block 1503). Thereafter, the unit 1001 executes the procedure of block 1502.

Conversely, if it is determined that a sub-window is displayed in sub-window 420A (Yes in block 1502), the overlap determination unit 1001 selects a display intended position having the priority higher than the display intended position corresponding to the display position of sub-window 420A (block 1504).

The overlap determination unit 1001 determines whether or not a sub-window is displayed in a layer higher than sub-window 410A having the video display area 410 in the selected display intended position (block 1505). If it is determined that a sub-window is displayed (Yes in block 1505), the overlap determination unit 1001 selects a display intended position having the next highest priority (block 1506). Then, the unit 1001 again executes the procedure of block 1505.

Conversely, in block 1505, if it is determined that a sub-window is not displayed (No in block 1505), the overlap determination unit 1001 transfers data of the selected display intended position to the display controller 1002. Then, the display controller 1002 executes a process of displaying sub-window 420A in the transferred display intended position (block 1507).

According to the foregoing procedure, even if another sub-window is displayed in sub-window 420A after sub-window 420A is displayed; it is possible to prevent sub-window 420A from being overlapped by another sub-window.

According to the foregoing embodiment, sub-window data on a point is acquired to determine whether or not sub-window 420A is overlapped by another sub-window. In this case, data on all sub-windows is acquired from the operating system, and then, based on the acquired sub-window data, determination may be made whether or not sub-window 420A is overlapped by another sub-window.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. An information processing apparatus configured to execute a browser, a player software and a first software, wherein the player software and the first software are browser plug-ins, wherein the player software is configured to play back video content received from a server in a first sub-window of the browser, wherein the first software is configured to display a user interface element in a second sub-window of the browser, wherein the second sub-window's layer is higher than the first sub-window's layer, and wherein the first software is further configured to execute a process in response to receiving an operation provided using the user interface element, the apparatus comprising:
a determination module configured to determine whether a third sub-window different from the first sub-window and the second sub-window is displayed in a first area; and
a display module configured to display the second sub-window in the first area when it is determined that the third sub-window is not displayed in the first area.

2. The apparatus of claim 1,
wherein the determination module is further configured to determine whether a fourth sub-window different from the first sub-window is displayed in a second area when the third sub-window is displayed in the first area; and
wherein the display module is further configured to display the second sub-window when it is determined that the fourth sub-window is not displayed.

3. The apparatus of claim 2, wherein the determination module is further configured to receive sub-window data associated with the sub-window of the browser located in a second position in the second sub-window, and to determine, based on the sub-window data, whether the fourth sub-window is displayed in the second sub-window.

4. The apparatus of claim 1, wherein the determination module is further configured to receive sub-window data associated with the sub-window of the browser located in a first position in the first area, and to determine, based on the sub-window data, whether the third sub-window is displayed, at least in part, on top of the first sub-window.

5. The apparatus of claim 1,
wherein the determination module is further configured to determine whether a fifth sub-window of the browser is displayed, at least in part, on top of the second sub-window after the second sub-window is displayed in the first area, and to determine whether a sixth sub-window is displayed in a third area which displays the second sub-window, when it is determined that the fifth sub-window is displayed; and
wherein the display module is further configured to display second sub-window in the third area when it is determined that the sixth sub-window is not displayed.

6. A method of controlling a display position of a user interface element in an information processing apparatus, wherein the apparatus is configured to execute a browser, a player software and a first software, wherein the player software and the first software are browser plug-ins, wherein the player software is configured to play back video content received from a server in a first sub-window of the browser, wherein the first software is configured to display a user interface element in a second sub-window of the browser, wherein the second sub-window's layer is higher than the first sub-window's layer, and wherein the first software is further configured to execute a process in response to receiving an operation provided using the user interface element, the method comprising
determining whether a third sub-window different from the first sub-window and the second sub-window is displayed in a first area; and
displaying the second sub-window in the first area when it is determined that the third sub-window is not displayed in the first area.

7. The method according to claim 6, further comprising:
determining whether a fourth sub-window of the browser is displayed in a position which overlaps with the second sub-window after the second sub-window is displayed; and
displaying the second sub-window in a position which does not overlap with the third and fourth sub-windows when it is determined that the fourth sub-window is displayed in the position which overlaps with second sub-window.

8. A non-transitory physical computer storage comprising computer-executable instructions for implementing a method of controlling a display position of a user interface element in a computer, wherein the computer is configured to display the user interface element in a first sub-window of a browser, wherein a layer of the first sub-window is higher than a layer of a second sub-window, wherein the computer is further configured to execute the browser and a player software, wherein the player software is a browser plug-in configured to play back video content received from a server, and wherein the computer is further configured to execute a process in response to receiving an operation provided using the user interface element, the method comprising:
determining whether a third sub-window different from the first and second sub-windows is displayed in a first area; and
displaying the second sub-window in the first area when it is determined that the third sub-window is not displayed in the first area.
